(19) United States
(12) Patent Application Publication
(10) Pub. No.: US 2015/0064438 A1
(43) Pub. Date: Mar. 5, 2015

(54) FIBROUS CORD AND METHOD OF MAKING

(71) Applicant: E I DU PONT DE NEMOURS AND COMPANY, Wilmington, DE (US)

(72) Inventors: MONTY C. MCNEIL, Midlothian, VA (US); MEHDI AFSHARI, Midlothian, VA (US)

(21) Appl. No.: 14/467,098

(22) Filed: Aug. 25, 2014

Related U.S. Application Data
(60) Provisional application No. 61/870,930, filed on Aug. 28, 2013.

(51) Int. Cl. D07B 1/16; B05D 3/00; D07B 1/06

(52) U.S. Cl. CPC D07B 1/162; D07B 1/0653; D07B 1/165; B05D 3/002; D07B 2205/3021; D07B 2205/2046; D07B 2205/2039; D07B 2205/205; D07B 2205/201; D07B 2205/2003; D07B 2501/2046; D07B 2501/2076; B05D 2256/00
USPC 428/221; 427/299

(57) ABSTRACT

A cord suitable for use in a tire or belt comprises a plurality of polymeric yarns or metallic strands wherein the yarns or strands are aligned parallel to each other to form a planar array, the yarns or strands being encapsulated by a solvent-free non-filamentary polymeric or rubber sheath, the yarns or strands have a tenacity of at least 3 grams per dtex and a modulus of at least 200 grams per dtex, and the ratio of the width of the encapsulated planar array to the thickness of the array is at least 2 to 1.

### BACKGROUND

1. Field of the Invention

This invention pertains to fibrous cords used in the manufacture of tires and mechanical rubber goods.

2. Description of Related Art

Fibrous cords or fabrics made with fibrous cords encased by rubber or elastomer are widely used as a structural component in the construction of tires and mechanical rubber goods such as belts and hoses. A flat reinforcing cord structure will have higher out-of-plane bending stiffness than in-plane bending stiffness. This is an attractive feature because it can contribute to several structural advantages in a tire such as enhanced braking and cornering performance as well as stabilizing tire belt reinforcements when flat structural cords are used as a carcass reinforcement in radial or bias tires. This invention pertains to a flat cord and a method of making the cord.

U.S. Pat. No. 8,146,339 to Hayashi describes a steel cord for a reinforcing rubber article composed of a plurality of steel filaments stranded in the same direction at the same stranding pitch, the number of the steel filaments being 6 to 12 and the diameter of the steel filaments being 0.08 to 0.21 mm.

U.S. Pat. No. 6,182,433 to Tagawa teaches a steel cord for the reinforcement of a rubber article and consists of a core of two steel filaments and a single sheath of seven or eight steel filaments, wherein diameters of core filament and sheath filament and twisting pitch have specified ranges, respectively.

United States Patent Publication 2005/0048280 to Stamper et al discloses an apparatus and process used to make tape which can be used as cap plies, breakers and reinforcement in the carcass of tires. The tape is made by dipping a plurality of single end cords in a solvent-based cement. The cords are converged before entering the dip pan so that they are fixed in a single plane when they are dipped. The cement, which comprises solvent and an elastomeric composition, is dried so that the majority of the solvent evaporates. The elastomeric composition remains, encapsulating the cords, thereby forming the tape.

### SUMMARY OF THE INVENTION

This invention pertains to a cord suitable for use in a tire or belt comprising a plurality of polymeric yarns or metallic strands wherein
(i) the yarns or strands are aligned parallel to each other to form a planar array,
(ii) the yarns or strands are encapsulated by a solvent-free non-filamentary polymeric or rubber sheath,
(iii) the yarns or strands have a tenacity of at least 3 grams per dtex and a modulus of at least 200 grams per dtex, and
(iv) the ratio of the width of the encapsulated planar array to the thickness of the array is at least 2 to 1.

### BRIEF DESCRIPTION OF THE DRAWINGS

FIGS. 1A to 1D show four different embodiments of this invention.

FIG. 2 shows a cross section of a bean-shaped filament or yarn.

### DETAILED DESCRIPTION

For purposes herein, the term “filament” is defined as a relatively flexible, macroscopically homogeneous body having a high ratio of length to width across its cross-sectional area perpendicular to its length. The filament cross section can be any shape, but is typically round or bean-shaped. Herein, the term “fiber” is used interchangeably with the term “filament”. The filaments can be any length. Preferably the filaments are continuous. A “yarn” is an assemblage of fibres or filaments to form a continuous strand. In the context of this invention, the term “yarn” also encompasses a “cabled yarn”. A cabled yarn is a yarn formed by twisting together two or more yarns. A yarn (multifilament yarn) contains a plurality of continuous filaments spun onto a bobbin in a package. A metallic filament is sometimes referred to as a strand or wire.

### Cords

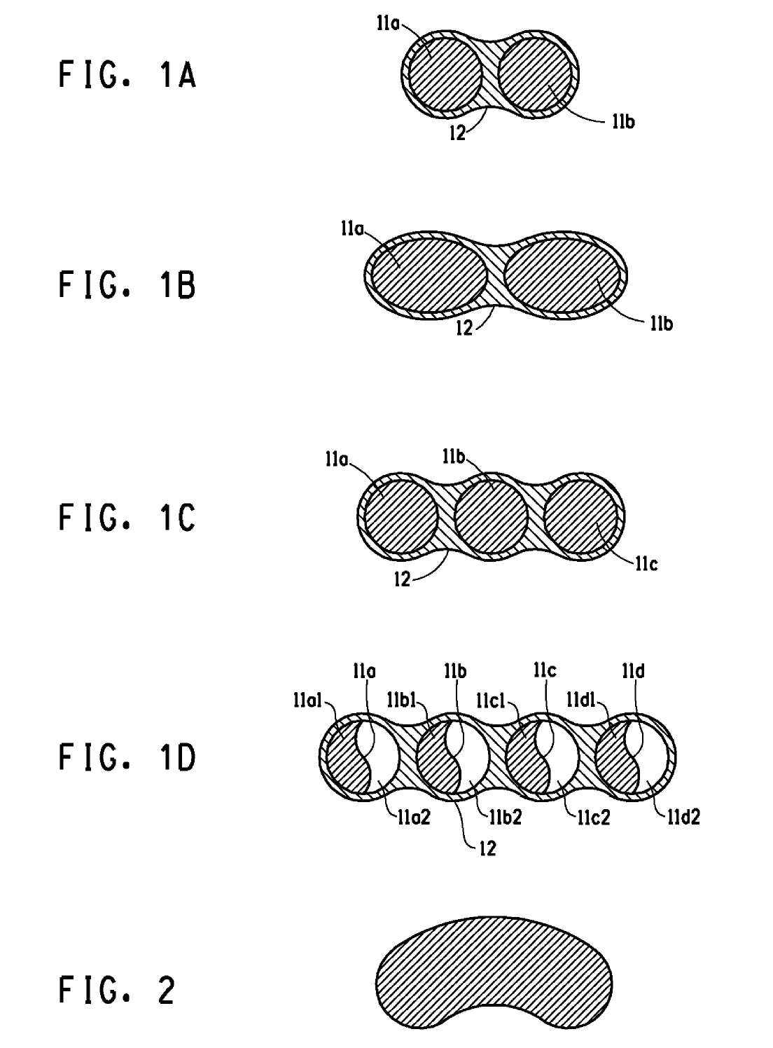

FIG. 1A shows a cord comprising two yarns or two metallic strands 11a and 11b encapsulated by a sheath 12. Some combination of yarn or strand may also be used. The yarns or strands are aligned parallel to each other to form a planar array. Preferably, adjacent yarns or strands do not touch each other. The yarns or strands have a tenacity of at least 3 grams per dtex and a modulus of at least 200 grams per dtex. The sheath comprises a solvent-free, non-filamentary, polymeric or rubber material.

FIG. 1C shows a cord comprising three yarns or three metallic strands 11a, 11b and 11c encapsulated by a sheath 12. Some combination of a yarn or strand may also be used. The yarns or strands are aligned parallel to each other to form a planar array. The yarns or strands have a tenacity of at least 3 grams per dtex and a modulus of at least 200 grams per dtex. The sheath comprises a solvent-free, non-filamentary, polymeric or rubber material.

FIG. 1D shows a cord comprising a sheath 12 encapsulating four cabled yarns 11a, 11b, 11c and 11d, each cabled yarn comprising component yarns 11a1 and 11a2; 11b1 and 11b2; 11c1 and 11c2; and 11d1 and 11d2, respectively. Some combination of a yarn or strand may also be used. The yarns or strands are aligned parallel to each other to form a planar array. The yarns or strands have a tenacity of at least 3 grams per dtex and a modulus of at least 200 grams per dtex. The sheath comprises a solvent-free, non-filamentary, polymeric or rubber material.

In some embodiments, the ratio of the width of the encapsulated planar array to the thickness of the array (aspect ratio) is at least 2 to 1. In some other embodiments, the ratio is at least 3:1 or even 4:1.

In some embodiments, the cross-sections of the yarns may be essentially round, oval or bean-shaped. FIG. 1B is similar to FIG. 1A except that the cross-section of the yarns is essentially oval.

In some embodiments, the flat cord comprises cabled yarns, such as yarns cabled from p-aramid and polyester component yarns. The yarns or component yarns of a cabled yarn may optionally be treated with a coating to improve adhesion to rubber. An example of such a coating is resorcinol-formaldehyde latex (RFL). Such a material and its method of application to yarn is well known in the art.

The ply and cabled yarns or strands are commonly twisted to enhance fatigue resistance from bending forces. Twist levels are defined by the level of bending fatigue resistance needed in the article.

### Filament Composition

In some embodiments, the filaments of the yarns are polymeric. Suitable polymers include aromatic polyamide, aromatic copolyamide, aliphatic polyamide, polyazole, polyester or combinations thereof.

A preferred aromatic polyamide is para-aramid. The term “aramid” means a polyamide wherein at least 85% of the amide (—CONH—) linkages are attached directly to two aromatic rings. Suitable aramid fibers include Twaron®, Sulfron®, Technora® all available from Teijin Aramid, Heracon™ from Kolon Industries Inc. or Kevlar® available from E.I. du Pont de Nemours and Company, Wilmington, Del. (DuPont). Aramid fibers are described in Man-Made Fibres—Science and Technology, Volume 2, Section titled Fibre-Forming Aromatic Polyamides, page 297, W. Black et al., Interscience Publishers, 1968. Aramid fibers and their production arealso disclosed in U.S. Pat. Nos. 3,767,756; 4,172,938; 3,869,429; 3,869,430; 3,819,587; 3,673,143; 3,354,127; and 3,094,511.

One preferred para-aramid is poly (p-phenylene terephthalamide) which is called PPD-T. By PPD-T is meant the homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as about 10 mole percent of the p-phenylene diamine or the terephthaloyl chloride, or perhaps slightly higher, provided only that the other diamines and diacid chlorides have no reactive groups which interfere with the polymerization reaction. PPD-T also means copolymers resulting from incorporation of other aromatic diamines and other aromatic diacid chlorides such as, for example, 2, 6-naphthaloyl chloride or chloro- or dichloroterephthaloyl chloride or 3, 4′-diaminodiphenylether. Additives can be incorporated into the aramid polymer. It has been found that up to as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

Another suitable fiber is one based on aromatic copolyamide which may be prepared by reaction of terephthaloyl chloride (TPA) with a 50/50 mole ratio of p-phenylene diamine (PPD) and 3,4′-diaminodiphenyl ether (DPE). Yet another suitable fiber is that formed by polycondensation reaction of two diamines, p-phenylene diamine and 5-amino-2-(p-aminophenyl) benzimidazole with terephthalic acid or anhydrides or acid chloride derivatives of these monomers.

An example of aliphatic polyamic is nylon. Suitable types of nylon include polyamide-6, polyamide-6,6, polyamide-6,10, polyamide-6,12, polyamide-11 and polyamide-12.

In some preferred embodiments the fiber is polyazole. Polyazoles include polyarenazoles such as polybenzazoles and polypyridazoles. Suitable polyazoles include homopolymers and, also, copolymers. Additives can be used with the polyazoles and up to as much as 10 percent, by weight, of other polymeric material can be blended with the polyazoles. Also, copolymers can be used having as much as 10 percent or more of other monomer substituted for a monomer of the polyazoles. Suitable polyazole homopolymers and copolymers can be made by known procedures, such as those described in or derived from U.S. Pat. Nos. 4,533,693, 4,703,103, 5,089,591, 4,772,678, 4,847,350, and 5,276,128.

Preferred polybenzazoles include polybenzimidazoles, polybenzothiazoles, and polybenzoxazoles and more preferably such polymers that can form fibers having yarn tenacities of 30 grams per denier (gpd) or greater. In some embodiments, if the polybenzazole is a polybenzothioazole, preferably it is poly (p-phenylene benzobisthiazole). In some embodiments, if the polybenzazole is a polybenzoxazole, preferably it is poly (p-phenylene benzobisoxazole) and more preferably the poly (p-phenylene-2,6-benzobisoxazole) called PBO.

Preferred polypyridazoles include polypyridimidazoles, polypyridothiazoles, and polypyridoxazoles and more preferably such polymers that can form fibers having yarn tenacities of 30 gpd or greater. In some embodiments, the preferred polypyridazole is a polypyridobisazole. One preferred poly(pyridobisozazole) is poly(1,4-(2,5-dihydroxy)phenylene-2,6-pyrido[2,3-d:5,6-d′]bisimidazole which is called PIPD. Suitable polypyridazoles, including polypyridobisazoles, can be made by known procedures, such as those described in U.S. Pat. 5,674,969.

The term “polyester” as used herein is intended to embrace polymers wherein at least 85% of the recurring units are condensation products of dicarboxylic acids and dihydroxy alcohols with linkages created by formation of ester units. This includes aromatic, aliphatic, saturated, and unsaturated di-acids and di-alcohols. The term “polyester” as used herein also includes copolymers (such as block, graft, random and alternating copolymers), blends, and modifications thereof. In some embodiments, the preferred polyesters include poly (ethylene terephthalate), poly (ethylene naphthalate), and liquid crystalline polyesters. Poly (ethylene terephthalate) (PET) can include a variety of comonomers, including diethylene glycol, cyclohexanedimethanol, poly(ethylene glycol), glutaric acid, azelaic acid, sebacic acid, isophthalic acid, and the like. In addition to these comonomers, branching agents like trimesic acid, pyromellitic acid, trimethylolpropane and trimethyloloethane, and pentaerythritol may be used. The poly (ethylene terephthalate) can be obtained by known polymerization techniques from either terephthalic acid or its lower alkyl esters (e.g. dimethyl terephthalate) and ethylene glycol or blends or mixtures of these. Another potentially useful polyester is poly (ethylene napthalate) (PEN). PEN can be obtained by known polymerization techniques from 2, 6 napthalene dicarboxylic acid and ethylene glycol.

Liquid crystalline polyesters may also be used in the invention. By “liquid crystalline polyester” (LCP) herein is meant polyester that is anisotropic when tested using the TOT test or any reasonable variation thereof, as described in U.S. Pat. No. 4,118,372. One preferred form of liquid crystalline polyesters is “all aromatic”; that is, all of the groups in the polymer main chain are aromatic (except for the linking groups such as ester groups), but side groups which are not aromatic may be present.

In some embodiments, the cord comprises at least one metallic strand. A preferred metal is steel or bronze. A suitable steel composition comprises a carbon content of from 0.60% to 1.1%, a manganese content ranging from 0.20 to 0.90% and a silicon content ranging from 0.10 to 0.90%. Other elements such as sulfur, phosphorous, chromium boron, cobalt, nickel and vanadium may each be present at a level below 0.5%. In preferred embodiments, the steel wire cross section is round or is essentially round.

### Sheath

The yarns or strands are encapsulated by a solvent-free, non filamentary, polymeric or rubber sheath. The polymer of the sheath may be a thermoplastic resin or a thermoset resin. Exemplary resins are polyamide, polyester, ionomeric, acrylic or urethane. Examples of polyamide are polyamide-6, polyamide-6,6, polyamide-6,10, polyamide-6,12, polyamide-11 and polyamide-12. Suitable rubbers include both natural rubber, synthetic natural rubber and synthetic rubber. Synthetic rubber compounds can be any which are dissolved by common organic solvents and can include, among many others, polychloroprene and sulfur-modified chloroprene, hydrocarbon rubbers, butadiene-acrylonitrile copolymers, styrene butadiene rubbers, chlorosulfonated polyethylene, fluoroelastomers, polybutadiene rubbers, polyisoprene rubbers, butyl and halobutyl rubbers and the like. Natural rubber, styrene butadiene rubber, polyisoprene rubber and polybutadiene rubber are preferred. Mixtures of rubbers may also be utilized. Another suitable material for the sheath is ethylene acrylic elastomer such as Vamac® available from DuPont. Low linear density polyethylene (LLDPE) may also be used.

### Tires

The flat cord of this invention may be used in tire components, such as carcass plies, belts, overlays and floaters. In some embodiments, the cords can be oriented to utilize the increased stiffness in the out-of-plane direction while maintaining the flexibility needed in the in-plane direction.

### Transmission and Conveyor Belts

The flat cord of this invention may be also be used in a power transmission or conveyor belt. In the belt, the cords are surrounded by elastomer. Cords are found in belt components such as primary reinforcing cords, cable constructions, strait warp, solid warp and breaker fabrics. In some embodiments, the cords can be oriented to utilize the increased stiffness in the out-of-plane direction while maintaining the flexibility needed in the in-plane direction.

### Method of Making a Cord

A method of making a cord suitable for use in a tire or belt comprises the steps of

(i) providing a plurality of polymeric filaments or yarns or metallic strands aligned parallel to each other to form a planar array,
(ii) encapsulating the planar array of (i) with a solvent-free, non-filamentary, polymeric or rubber sheath,
wherein
(a) the filaments, yarns or strands have a tenacity of at least 3 grams per dtex and a modulus of at least 200 grams per dtex, and
(b) the ratio of the width of the encapsulated planar array to the thickness of the array is at least 2 to 1.

### EXAMPLES

### Example 1

A cabled yarn cord may be made by combining a 1333 dtex (1200 denier) Kevlar® AP yarn available from DuPont with a 1111 dtex (1000 denier) polyester yarn available from Kordsa Global, Chattanooga, Tenn. Such a construction may be referred to as a 1200/1+1000/1. The cabled yarn can be coated with an RFL. Four such cabled yarns may be placed side by side, but not touching and encapsulated by a thermoplastic polymer blend to form a flat cord having a nominal thickness of 0.89 mm (0.035 inches) and a nominal width of 3.3 mm (0.130 inches). This flat cord would have an aspect ratio of width to thickness of 3.7. Suitable encapsulate materials that may be used are low linear density polyethylene, ethylene acrylic elastomer, polyamide or blends thereof. An example of a suitable blend is one comprising 35 percent by weight of ethylene acrylic elastomer and 65 percent by weight of polyamide. A suitable LLDPE is Marflex® D143 available from Chevron Phillips Chemical Company LP, The Woodlands, Tex. The ethylene acrylic elastomer may be Vamac® from DuPont. A suitable polyamide 66 is Zytel®, also available from DuPont or Ultramid® B33L01 from BASF Corporation, Florham Park, N.J.

Samples of flat cords made as above when compared with conventional circular or bean-shaped cords comprising the above formulations or 100% polyester or 100% polyamide or 100% p-aramid will show enhanced improvements in tests such as bending stiffness. Flat cords may be encapsulated in elastomeric shapes, such as sheet or beam and then tested for bending stiffness in known three point flexural tests for modulus of elasticity in bending and flexural strain. Appropriate test methods include ASTM D790: Standard Test Methods for Flexural Properties of Unreinforced and Reinforced Plastics and Electrical Insulating Materials and ISO 178: Plastics—Determination of Flexural Properties.

What is claimed is:

1. A cord suitable for use in a tire or belt comprising a plurality of polymeric yarns or metallic strands wherein
the yarns or strands are aligned parallel to each other to form a planar array,
the yarns or strands, are encapsulated by a solvent-free non-filamentary polymeric or rubber sheath,
the yarns or strands have a tenacity of at least 3 grams per dtex and a modulus of at least 200 grams per dtex, and
the ratio of the width of the encapsulated planar array to the thickness of the array is at least 2 to 1.

2. The cord of claim 1, wherein the polymer of the filaments of the yarns is selected from the group consisting of aromatic polyamide, aromatic copolyamide, aliphatic polyamide, polyazole, polyester and combinations thereof.

3. The cord of claim 1, wherein the metallic strand is steel.

4. The cord of claim 1, wherein the polymer of the sheath is selected from the group consisting of a thermoplastic resin and a thermoset resin.

5. The cord of claim 1, wherein the yarns are cabled yarns.

6. The cord of claim 2, wherein the aromatic polyamide is para-aramid.

7. The cord of claim 4, wherein the resin is selected from the group consisting of polyamide, polyester, low linear density polyethylene, ethylene acrylic elastomer and urethane.

8. The cord of claim 5, wherein the cabled yarn comprises p-aramid and polyester as component yarns.

9. A tire comprising the cord of claim 1 and an elastomer surrounding the cord.

10. A power transmission or conveyor belt comprising the cord of claim 1 and an elastomer surrounding the cord.

11. A method of making a cord suitable for use in a tire or belt comprising the steps of
(i) providing a plurality of polymeric yarns or metallic strands aligned parallel to each other to form a planar array,
(ii) encapsulating the planar array of (i) with a solvent-free, non-filamentary polymeric or rubber sheath,
wherein
(a) the yarns or strands have a tenacity of at least 3 grams per dtex and a modulus of at least 200 grams per dtex, and
(b) the ratio of the width of the encapsulated planar array to the thickness of the array is at least 2 to 1.

12. The method of claim 11, wherein the polymer of the filaments of the yarns is selected from the group consisting of aromatic polyamide, aromatic copolyamide, aliphatic polyamide, polyazole, polyester and combinations thereof.

13. The method of claim 11, wherein the metallic strand is steel.

14. The method of claim 11, wherein the polymer of the sheath is selected from the group consisting of a thermoplastic resin and a thermoset resin.

15. The method of claim 12, wherein the aromatic polyamide is para-aramid.

16. The method of claim 14, wherein the resin is selected from the group consisting of polyamide, polyester, low linear density polyethylene, ethylene acrylic elastomer and urethane.
